(19) United States
(12) Patent Application Publication
(10) Pub. No.: US 2012/0120077 A1
(43) Pub. Date: May 17, 2012

(54) RECRUITING ADDITIONAL RESOURCE FOR HPC SIMULATION

(76) Inventors: Greg Scantlen, Albuquerque, NM (US); Gary Scantlen, Albuquerque, NM (US)

(21) Appl. No.: 13/346,720

(22) Filed: Jan. 9, 2012

Related U.S. Application Data
(63) Continuation-in-part of application No. 12/895,554, filed on Sep. 30, 2010.

(51) Int. Cl. G06T 11/20; G06F 15/16

(52) U.S. Cl. 345/440; 345/502

(57) ABSTRACT

Graphics processing units (GPUs) deployed in general purpose GPU (GPGPU) units are combined into a GPGPU cluster. Access to the remote GPGPU cluster is then offered as a service to users who can use their own computers to communicate with the GPGPU cluster. The users' computers can be standalone desktop systems, laptops, or even another GPGPU cluster. The user can run a parallelized application locally and patiently wait for results or can dynamically recruit the remote GPGPU cluster to obtain those results more quickly. Dynamic recruitment means that the users can add remote GPGPU resources to a running application.

### CROSS REFERENCE TO RELATED APPLICATIONS

This patent application is a continuation in part of U.S. patent application Ser. No. 12/895,554, entitled “GPGPU SYSTEMS AND SERVICES” which was filed on Sep. 30, 2010 and which is incorporated herein by reference in its entirety.

### TECHNICAL FIELD

Embodiments relate to computing clusters, cloud computing, and general purpose computing based on graphic processor units. Embodiments also relate to massive computing power offered on a subscription basis. Embodiments additionally relate to profiling massively parallel programs on a variety of cluster configurations.

### BACKGROUND OF THE INVENTION

Parallelization is a well-known way to more rapidly obtain computational results. The reason is quite simply that two processors or computers working concurrently on a job should finish more quickly than if only one of the computers is used. One of the currently popular techniques for obtaining parallelization is to connect a great many computers together and to hand portions of a job to the various computers. This technique is often called scatter/gather because the input data is scattered throughout the cluster and intermediate results are then gathered together and processed into the final result.

At the center of most scatter/gather implementations is a controlling or “master” program that is responsible for dividing the work and handing it out to the various nodes in the cluster. Two libraries for standardizing scatter/gather are MPI (message passing interface) and PVM (parallel virtual machine). Typically, the number of processes, computers, and CPUs in each computer are known ahead of time and codified into a configuration data file. The configuration data file also typically includes identification information for each computer such as its IP address. Essentially, the configuration file defines a virtual machine consists of a number of individual computers. The parallelization libraries can then be given the configuration data and a specially designed computer run on the virtual machine.

These statically defined virtual machines have enabled a great number of computations to be performed that had previously been thought too huge to attempt. There are problems with the statically defined virtual machines such as hardware failures and changing the virtual machine by adding or removing computers.

Another recent innovation is “cloud computing”. In general, service providers install and maintain an immense number of computers and allow users to have remote access. The service provider doesn't particularly care what programs are being executed, just that the computer is running and connected to the network. A user can access a compute resource in the cloud, use it for minutes, hours, or days, and then release it. The user pays only for the resources consumed.

Yet another recent innovation is “GPGPU” (general purpose graphics processing unit) computing. Many computers have a CPU and a GPU. The CPU is a good general purpose machine that can do many tasks well. The GPU, however, is optimized for graphics. It turns out that the graphics capabilities of GPUs also make them ideal for other mathematically intensive applications. The major graphics chip producers have begun supporting the use of GPUs for non-graphics applications. This is sometimes referred to as GPU acceleration.

Molecular dynamics (MD) simulations are mathematically intense and have been shown to benefit greatly from the use of GPU acceleration. Furthermore, compute clusters wherein the individual computers have one or more powerful GPU are incredibly promising for the rapid simulation of molecular systems such as proteins and carbon nanotubes. Programs for running the simulations can receive as input a description of the positions and velocities of the atoms (or other “atomic” unit) in the system. The simulation also requires information about the system's environment such as temperature, applied forces, etc. The simulation can then step through time and calculate each atom's new position and velocity at each time step. The simulation attempts to thereby calculate the results of collisions, pulls, pushes, and other interactions amongst the atoms. The simulation can output trajectory data describing the positions and velocities of the atoms at the various time steps.

A visualization program can accept the trajectory data and display it, perhaps even in three dimensions using a 3D capable display. The visualization program can even display an animation by stepping through the time sequence of atomic trajectories. Furthermore, the output of the simulation can be fed directly into the visualization program so that a person can observe the changing system as each time step is computed and displayed.

The complexity of a MD system determines both how quickly each time step can be simulated and displayed. As more and more computer hardware is brought to bear, the faster the computations can be performed. This is important because faster simulation and display opens up the possibility for human interaction. A person can change the environment by, for non-limiting example, applying a force, changing the temperature, adding atoms, or removing atoms. Too slow a simulation means the person gets bored and walks away. A fast enough simulation means the person can play or work with the simulated molecular system. A person can change the environment through a set of GUI controls such as a temperature slider or even through a haptic device for directly manipulating the simulated atoms.

In order for people to be inventive with MD systems, they need enough computing power to enable a reasonable level of interaction with MD simulations. Most people and organizations can not afford to purchase and maintain computing systems having enough power that a person can interact with an MD simulation and receive near real-time feedback. Systems and methods providing more people and organizations with access to massive computational power are needed.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

It is therefore an aspect of the embodiments that a highly parallelized simulation code contains instructions for simultaneous execution by a large number of processors. The simulation code simulates a physical system such as a collection of atoms that attract each other, repel each other, form molecular bonds with each other, transfer energy with each other, and otherwise interact and react is the manner of atomic and molecular groupings in nature.

It is another aspect of the embodiments that a GPGPU cluster provides processors for running the simulation. The GPGPU cluster includes a plurality of central processing units (CPUs) and a plurality of general purpose graphics processing units (GPGPUs).

It is yet another aspect of the embodiments that a user can observe the simulation on a display unit and provide input to the simulation through an input device. For example, a molecular dynamics simulation can provide graphical output at discrete time steps and the user can move simulated atoms around, change the simulated temperature, or otherwise change the simulated system as the simulation steps along in time.

It is a further aspect of the embodiments that a master program divides the computational work required by the simulation code amongst the available processing units. The simulation code can produce data about the simulated physical system such as the positions and velocities of individual atoms. A visualization module can interpret the data to thereby produce the graphical representation of the simulated physical system that the user observes. Note that certain embodiments can produce two slightly offset graphical representations that can be provided to a 3D capable display such that the user can observe and interact with a 3D visualization of the simulated physical system.

### BRIEF DESCRIPTION OF THE DRAWINGS

The accompanying figures, in which like reference numerals refer to identical or functionally similar elements throughout the separate views and which are incorporated in and form a part of the specification, further illustrate aspects of the embodiments and, together with the background, brief summary, and detailed description serve to explain the principles of the embodiments.

FIG. 1 illustrates a subscription based service by which a user can test an algorithm, application or utility upon a number of different GPGPU configurations in accordance with aspects of the embodiments;

FIG. 2 illustrates one possible GPGPU configuration configurations in accordance with aspects of the embodiments;

FIG. 3 illustrates a GPGPU configuration having numerous GPGPU units configurations in accordance with aspects of the embodiments;

FIG. 4 illustrates a user having local access to a local GPGPU cluster accessing a service provider's configurations in accordance with aspects of the embodiments; and

FIG. 5 illustrates a high level flow diagram of recruiting additional computational resources configurations in accordance with aspects of the embodiments.

### DETAILED DESCRIPTION

The particular values and configurations discussed in these non-limiting examples can be varied and are cited merely to illustrate at least one embodiment and are not intended to limit the scope thereof. In general, the figures are not to scale.

Graphics processing units (GPUs) deployed in general purpose GPU (GPGPU) units are combined into a GPGPU cluster. Access to the remote GPGPU cluster is then offered as a service to users who can use their own computers to communicate with the GPGPU cluster. The users' computers can be standalone desktop systems, laptops, or even another GPGPU cluster. The user can run a parallelized application locally and patiently wait for results or can dynamically recruit the remote GPGPU cluster to obtain those results more quickly. Dynamic recruitment means that the users can add remote GPGPU resources to a running application.

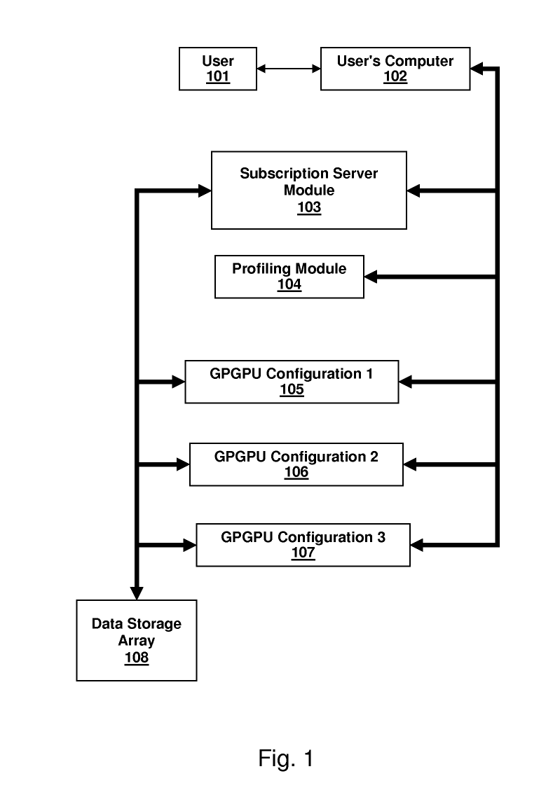

FIG. 1 illustrates a subscription based service by which a user 101 can test an algorithm, application, or utility upon a number of different GPGPU configurations 105, 106, 107. The user 101 can access the user's computer 102 to develop, compile, etc a GPGPU application. A service provider can provide the user with access to a number of different GPGPU configurations such as GPGPU configuration 1 105, GPGPU configuration 2 106, and GPGPU configuration 3 107. The user 101 can download the application to a suitably configured GPGPU cluster and run it. A data storage array 108 can store data for the user such that the data is available to the user's application. A profiling module 104 can track the number of processors, amount of processing time, amount of memory, and other resources utilized by the application and report those utilizations back to the user.

The user's computer 102 connects to the service using a communications network. As illustrated, a second communications network can interconnect the configurations, modules, and data storage array 108. For example, the user's computer might communicate over the internet whereas the GPGPU cluster communicates internally using infiniband or some other very high speed interconnect. The various networks must also include network hardware as required (not shown) such as routers and switches.

A subscription module 103 can control the user's access to the GPGPU configurations such that only certain users have access. The subscription module 103 can also limit the amount of resources consumed by the user such as how much data can be stored in the data storage array 108 or how much total GPU time can be consumed by the user. Alternatively, the subscription module can track the user's resource consumption such that the user 101 can be invoiced after the fact or on a pay-as-you-go basis.

The user's application can include a specification of the GPGPU cluster configuration. In this case, the user can produce multiple applications that are substantially similar with the exception that each specifies a different configuration. Testing and profiling the different applications provides the user with information leading to the selection of a preferred GPGPU cluster configuration for running the application. As such, the cluster configuration can be tuned to run an application such as a molecular dynamics simulator. Alternatively, the application can be tuned for the configuration.

A service provider can provide access to a number of different cluster configurations. A user accessing the service can submit an application that is then run and profiled on each of the available configurations or on a subset of the available configurations. This embodiment eases the user's burden of generating numerous cluster configuration specifications because those specifications are available from the service provider.

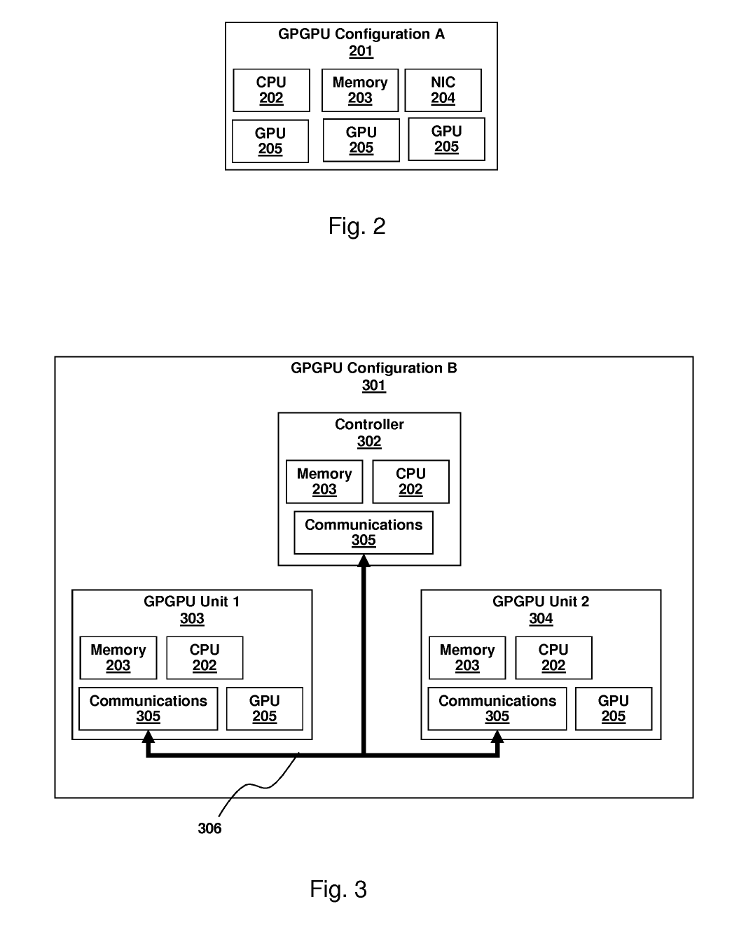

FIG. 2 illustrates one possible GPGPU configuration. GPGPU configuration A 201 has a CPU 202, memory 203, a network interface 204, and three GPUs 205. In GPGPU configuration A 201 a single computer holds all the processing capability. Note that GPGPU configuration A 201 can be deployed as a unit within a much larger configuration that contains numerous computers. However, should GPGPU configuration A encompass all of the available resources then the subscription server module and the profiling module can run as application programs on the single computer.

FIG. 3 illustrates a GPGPU configuration having numerous GPGPU units. GPGPU configuration B 301 has a control computer 301, GPGPU unit 1 303 and GPGPU unit 2 304 interconnected by a communications network 306. Note that each of the GPGPU units has a single GPU 205 and the control computer 302 has none. As such, this is a non limiting example because a controller can contain multiple GPUs as can each of the GPGPU units. The communications network can be a single technology such as infiniband or Ethernet. Alternatively, the communications network can be a combination of technologies. In any case, the communications module 305 in each computer has the hardware, firmware, and software required for operation with the communications network 306. The control computer 302 can run the subscription server module and the profiling module as application programs.

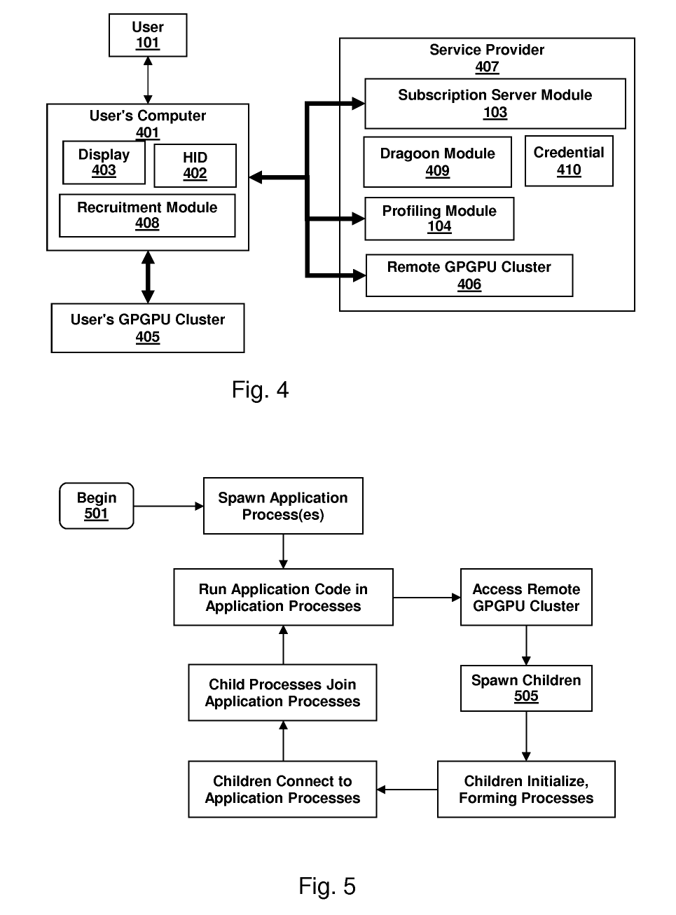

FIG. 4 illustrates a user 101 having local access to a local GPGPU cluster 405 accessing a service provider 407. The user 101 can work with the user's computer 401 to initiate, display and control an application. The user's computer has a display 403 and various human input devices 402 such as mouse, keyboard, or haptic device. Note that a haptic device is actually both an input device and an output device because the user manipulates the device and the device provides force feedback to the user. The user's computer 401 can be directly connected to the user's GPGPU cluster 405. In fact, the user's computer 401 can be part of the user's GPGPU cluster. The application can be run with the user I/O functions performed by the user's computer and the computationally intensive tasks divided amongst the cluster's computational resources.

The user 101, deciding that the application is running too slowly, can opt to recruit remote computational resources. The user 101 can request additional processing power through a recruitment module 408. The recruitment module can contact a service provider's 407 subscription server module 103 and perform whatever authentication ritual is required. In return, the subscription server module 103 can grant access to some or all of the processors in the remote GPGPU cluster 406. One method of granting access is to provide a credential 410 that is then supplied to a dragoon module 409. The dragoon module 409 can examine the credential 410 and, based on data within the credential, provide access to as many processors as the subscriber is allowed. Once access is granted, a portion of the application is offloaded to the remote GPGPU cluster. The master program controlling the child processes should detect when access to the remote processors is lost, perhaps via revoked credential, and recover. Recovery can include downloading intermediate results or time step calculations along with reapportioning the processing tasks amongst the remaining processors. Credentials can be revoked when the subscription runs out of funds, passes a usage threshold, or for some other reason.

FIG. 5 illustrates a high level flow diagram of recruiting additional computational resources. After beginning 501, the application processes are spawned 502 and then the application run in the application processes 503. To recruit more resources, the remote GPGPU cluster is accessed 504 and children spawned there 505. The children initialize and form processes 506 on the remote GPGPU cluster. The children can then connect to the application processes 507 and thereafter join with the application processes 508 to run application code 503.

Dynamic process management capabilities in the recent MPI-2 specification provide the ability to add and remove computational resources as an application runs. These capabilities were added primarily to provide a “hot swap” capability so that the computers in a cluster could fail, be restarted, and exchanged without forcing a restart of an application. Such a capability is very important when the application has been running for days or weeks. The ability to recruit remote computational resources from a service provider is made possible by repurposing the dynamic process management capabilities of MPI-2 or a similar library.

### Interactive Molecular Dynamic Simulation Examples

The following non-limiting usage examples detail the running, observation, and manipulation of a large molecular dynamics simulation. The specific names of software applications and packages being currently used are part of the example. The MD simulation itself can be performed by NAMD (Not (just) Another Molecular Dynamics program) or LAMMPS (Large-scale Atomic/Molecular Massively Parallel Simulator) with the output going to VMD (Visual Molecular Dynamics). The data may need to pass from LAMMPS through a translator to VMD of which IMD is an example. The user's computer can directly run VMD to display an animation of the simulation out put or a cluster node can run VMD display remotely through an application like VirtualGL. The haptics device is connected to the user's computer which transmits the user's haptic inputs to MD simulation applications.

In a first embodiment, the user's computer can be a very powerful machine having numerous GPU units. This is the simplest case where all the applications run on that one machine.

In a second embodiment, the user also has a GPGPU cluster. NAMD (or LAMMPS) is distributed throughout the cluster and streams data to the user's computer running VMD. This may require a fast link between cluster and display computer. This is particularly true when the displaying the animation in 3D. A slower link can be used if the cluster runs VMD and uses VirtualGL to display to the user.

In a third embodiment, a remote cluster can run NAMD, VMD, and VirtualGL while the user's computer runs only VirtualGL. A reasonably fast and low lag internet connection can provide adequate interactive MD simulation and visualization.

In a fourth embodiment, the user begins with the second embodiment detailed above but wants more speed. The user can recruit a remote GPGPU cluster. Recruitment itself is discussed above. Portions of the MD simulation can be simply passed over to the remote cluster. One way to obtain this is to momentarily stop the simulation, reconfigure it to use all the resources, and restart it. This may require a fast low lag connection to the remote cluster. Another way is to stop the simulation and send it completely to the remote cluster such that the user, in essence, switches from using the second embodiment to using the third embodiment. Yet another way is for the simulation to examine the multiprocessing architecture (eg the MPI configuration) each time step and then reconfigure itself accordingly when the architecture changes.

The computers in the cluster may have a wake-on-Ian functionality wherein the computer enters a boot-up procedure when certain network traffic is detected. Current computers normally boot by running through a bios procedure wherein the computer loads operating instructions from an on-board static memory, such as a BIOS chip. Most computers load an operating system from a hard drive or similar local storage device after the BIOS procedures complete. Instead, the BIOS can be a full operating system kernel such that the computer goes from a powered off state to running a full operating system in a very short time.

Alternatively, the BIOS can cause the computer to obtain its operating system from a server. Currently, this is often referred to as “remote network boot via PXE”. This remote network boot process can cause the computer to download an operating system kernel, a disk image, or both. Downloaded disk images are usually loaded in ramdisks which are mounted into the computer's file system as hard drives, network drives (such as NFS partitions), and flash drives are.

The computers in a GPGPU cluster can take full advantage of wake-on-LAN, remote booting, network drives, and directly booting an operating system kernel (such as a linux kernel). As such, entire GPGPU compute clusters can wake-on-LAN and load an operating system and disk images that cause the computers to use MPI-2 type dynamic process control to join into an already configured and running cluster configuration. Note that the server that downloads kernels and images into the GPGPU computers can be instructed which kernal and disk image combinations to provide to any other computer because the remotely booting computer is automatically identified by a network identifier such as the MAC address on a LAN port.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

The embodiments of the invention in which an exclusive property or right is claimed are defined as follows. Having thus described the invention

What is claimed is:

1. A system comprising:
a highly parallelized simulation code comprising data and executable instructions to be executed by a plurality of processing units and wherein the simulation code simulates a physical system;
a GPGPU cluster comprising a plurality of central processing units (CPUs) and a plurality of general purpose graphics processing units (GPGPUs) and wherein the plurality of processors comprise the CPUs and GPGPUs;
a display unit that presenting a graphical representation of the simulated physical system to a user;
an input device through which the user interacts with the simulated physical system;
a master program that divides the computational work required by the simulation code amongst the processing units; and
a visualization module that interprets data produced by the simulation code to thereby produce the graphical representation of the physical system.

2. The system of claim 1 further comprising a recruitment module and a plurality of additional processors wherein the user requests more processors from the recruitment module, wherein the recruitment module gains access to the additional processors, and wherein the recruitment module adds the additional processors to the plurality of processors amongst which the computational work required by the simulation program is divided.

3. The system of claim 2 wherein the simulation code is a molecular dynamics code that simulates molecular systems such that the simulated physical system is a plurality of simulated atoms interacting with one another.

4. The system of claim 3 wherein the user interacts with the simulated atoms by moving at least one simulated atom.

5. The system of claim 3 wherein the user interacts with the simulated atoms by changing the temperature of the simulated physical system.

6. The system of claim 1 wherein the visualization module comprises a visual data generation module and a visual data presentation module wherein the visual data generation module produces visualization data from a simulation code output and wherein the visual data presentation module process the visualization data for display to the user.

7. The system of claim 2 wherein the recruitment module causes simulation code routines to be transferred to the additional processors such that they operate in cooperation with the master program.

8. The system of claim 2 wherein the recruitment module communicates with a subscription module to obtain a credential that authorizes access to the additional processors.

9. The system of claim 8 wherein the subscription module access to at least some of the additional processors and wherein the master program reapportions the computational work required by the simulation code amongst the remaining processing units.

10. A system comprising:
a communications network;
a GPGPU cluster comprising a plurality of central processing units (CPUs) and a plurality of general purpose graphics processing units (GPGPUs) and wherein the plurality of processors comprise the CPUs and GPGPUs;
a dragooning module that receives a request for processors from a recruitment module and provides the recruitment module with access to the plurality of processors to thereby add processing power to a master program running in cooperation with the recruitment module.

11. The system of claim 10 further comprising a subscription module that bills a requester for access to the processors.

12. The system of claim 11 wherein the dragoon module requires that the request include a credential and subscription module provides the credential.

13. The system of 12 wherein a highly parallelized simulation code comprising data and executable instructions is executed by processors units and wherein the simulation code simulates a physical system.

14. The system of claim 13 wherein the simulation code is a molecular dynamics code that simulates a molecular system such that the simulated physical system is a plurality of simulated atoms interacting with one another.

15. The system of claim 14 wherein the molecular dynamics code simulates the molecular system as at a series of time steps such that the user observes a presentation of simulated atomic and molecular movement and interaction changing over time.

16. The system of claim 15 wherein the subscription module revokes the credential and provides the master program or a related program with access to simulation data produced by the clusters such that the simulation data is available but the additional processing power is not.

17. The system of claim 10 wherein the processors are not powered on and wherein a signal from the dragoon module causes processors to receive power and thereby become available for processing executable instructions.

18. A system comprising:
a front end computer comprising a display unit, an input unit, and an interface to a communications network;
a highly parallelized simulation code stored on the frontend computer and comprising data and executable instructions to be executed by a plurality of processors and wherein the simulation code simulates a physical system;
a visual data generation module that produces visualization data from a simulation code output;
a recruitment module that uses the communications network to access a dragoon module running on a remote computer wherein the dragoon module provides the recruitment module with access to a plurality of processors and wherein the plurality of processors comprises a plurality of central processing units (CPUs) and a plurality of general purpose graphics processing units (GPGPUs);
a master program that receives access to the processors and divides the computational work required by the simulation code and by the visual data generation module amongst the processing units such that the simulation code output is produced and the visualization data is produced; and
a visual data presentation module running on the computer that receives the visualization data and displays it to a user.

19. The system of claim C1 wherein the simulation code simulates the physical system as at a series of time steps such that the user observes a presentation of simulated physical system changing over time.

20. The system of claim C2 wherein the user manipulates the input unit to thereby perturb the physical system.
